(19) United States
(12) Patent Application Publication
(10) Pub. No.: US 2024/0176420 A1
(43) Pub. Date: May 30, 2024

(54) OPERATION CONTROL DEVICE, OPERATION CONTROL METHOD, AND COMPUTER-READABLE STORAGE MEDIUM

(71) Applicant: JVCKENWOOD Corporation, Yokohama-shi (JP)

(72) Inventor: Yuya Takehara, Yokohama-shi (JP)

(21) Appl. No.: 18/434,899

(22) Filed: Feb. 7, 2024

Related U.S. Application Data
(63) Continuation of application No. PCT/JP2022/023847, filed on Jun. 14, 2022.

(30) Foreign Application Priority Data
Sep. 15, 2021 (JP) 2021-150453
Sep. 15, 2021 (JP) 2021-150596

(51) Int. Cl. G06F 3/01

(52) U.S. Cl. CPC G06F 3/015

(57) ABSTRACT

An operation control device includes: a brain-information acquiring unit configured to acquire brain information of a user; a determining unit configured to determine whether the brain information acquired by the brain-information acquiring unit is brain information corresponding to an execution command representing an operation to operate an operation object; an executing unit configured to execute processing corresponding to the execution command when the determining unit determines that brain information corresponding to the execution command is acquired; and a first notifying unit configured to notify, when a first processing signal corresponding to the execution command is being transmitted to the operation object or when a second processing signal from the operation object is being received, surroundings of at least one of the user and the operation object that the first processing signal or the second processing signal is being processed.

### CROSS-REFERENCE TO RELATED APPLICATIONS

This application is a Continuation of PCT International Application No. PCT/JP2022/023847 filed on Jun. 14, 2022 which claims the benefit of priority from Japanese Patent Applications No. 2021-150453 and No. 2021-150596, both filed on Sep. 15, 2021, the entire contents of all of which are incorporated herein by reference.

### BACKGROUND

The present disclosure relates to an operation control device, an operation control method, and a computer-readable storage medium.

In recent years, technology for measuring brain information has advanced, and brain-machine interfaces (BMIs), which directly connect the brain to machines, are becoming a reality. As such a technology, for example, there is one described in JP-A-2013-117957. JP-A-2013-117957 is about a technique to obtain multiple steady-state visual evoked potential signals from a user when the user is stimulated, to supply a system command signal.

In the conventional BMI systems, when a user commands a robot silently to “move forward, a forward movement command by which the robot moves forward is recalled, and when the forward movement command is detected, it causes the robot to move forward. At this time, people around the robot do not know how the user is trying to move the robot, and how the robot is going to move. Therefore, there is a risk that the robot operates without prior notification and comes into contact with people nearby. Moreover, if the user is talked to by someone while recalling a command, a wrong command can be recalled.

### SUMMARY

An operation control device according to one aspect of the present disclosure includes: a brain-information acquiring unit configured to acquire brain information of a user; a determining unit configured to determine whether the brain information acquired by the brain-information acquiring unit is brain information corresponding to an execution command representing an operation to operate an operation object; an executing unit configured to execute processing corresponding to the execution command when the determining unit determines that brain information corresponding to the execution command is acquired; and at least one of: a first notifying unit configured to notify, when a first processing signal corresponding to the execution command is being transmitted to the operation object or when a second processing signal from the operation object is being received, surroundings of at least one of the user and the operation object that the first processing signal or the second processing signal is being processed, and a second notifying unit configured to notify, when a first processing signal corresponding to the execution command is being transmitted to the operation object or when a second processing signal from the operation object is being received, the user that the first processing signal or the second processing signal is being processed.

An operation control method according to another aspect of the present disclosure includes: acquiring brain information of a user; determining whether the acquired brain information is brain information corresponding to an execution command representing an operation to operate an operation object; executing processing corresponding to the execution command when it is determined that brain information corresponding to the execution command is acquired; and notifying, when a first processing signal corresponding to the execution command is being transmitted to the operation object or a second processing signal from the operation object is being received, at least one of the user, surroundings of the user, and surroundings of the operation object that the first processing signal or the second processing signal is being processed.

A non-transitory computer-readable storage medium according to still another aspect of the present disclosure stores a program causing a computer to execute: acquiring brain information of a user; determining whether the acquired brain information is brain information corresponding to an execution command representing an operation to operate an operation object; executing processing corresponding to the execution command when it is determined that brain information corresponding to the execution command is acquired; and notifying, when a first processing signal corresponding to the execution command is being transmitted to the operation object or a second processing signal from the operation object is being received, at least one of the user, surroundings of the user, and surroundings of the operation object that the first processing signal or the second processing signal is being processed.

### BRIEF DESCRIPTION OF THE DRAWINGS

FIG. 1 is a block diagram illustrating a configuration example of an operation control device according to a first embodiment;

FIG. 2 is a flowchart illustrating a flow of transmission processing of the operation control device according to the first embodiment;

FIG. 3 is a flowchart illustrating a flow of reception processing of the operation control device according to the first embodiment;

FIG. 4 is a graph representing brain activity levels corresponding to measurement positions in a brain;

FIG. 5 is a graph representing temporal changes of a brain wave at a specific measurement position in the brain;

FIG. 6 is a block diagram illustrating a configuration example of an operation control device according to a second embodiment;

FIG. 7 is a flowchart illustrating a flow of transmission processing of the operation control device according to the second embodiment; and

FIG. 8 is a flowchart illustrating a flow of reception processing of the operation control device according to the second embodiment.

### DETAILED DESCRIPTION

Hereinafter, embodiments of an operation control device, an operation control method, and a computer program according to the present disclosure will be explained in detail with reference to the accompanying drawings. The embodiments below are not intended to limit the present invention.

### First Embodiment

### Operation Control Device

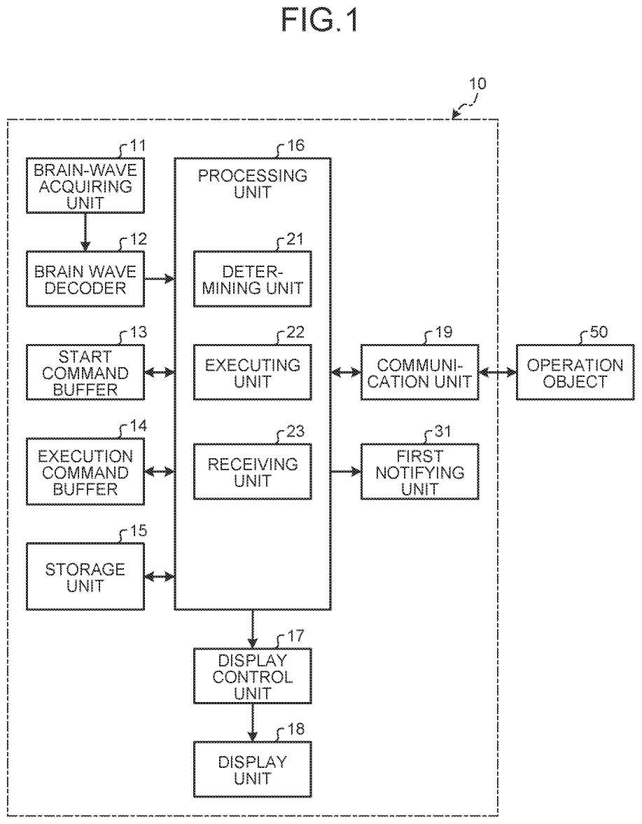

FIG. 1 is a block diagram illustrating a configuration example of an operation control device according to a first embodiment.

In the first embodiment, as illustrated in FIG. 1, an operation control device 10 is to control an operation object 50 based on brain information of a user. The operation control device 10 includes a brain-wave acquiring unit (brain-information acquiring unit) 11, a brain wave decoder 12, a start command buffer 13, an execution command buffer 14, a storage unit 15, a processing unit 16, a display control unit 17, a display unit 18, a communication unit 19, and a first notifying unit 31.

The operation object 50 is, for example, a robot, but is not limited to robots, and may be a device activated by communication, and the like. Although not illustrated, the operation object 50 is equipped with a driving device, a control device that controls the driving device, and a communication unit capable of receiving a control signal and the like. In the operation object 50, the control device activates a robot by driving the driving device when the communication unit receives a control signal.

The brain-wave acquiring unit 11 is wearable on the head of a user. The brain wave decoder 12, the processing unit 16, the display control unit 17, the display unit 18, and the communication unit 19 may be worn by the user, or may be placed at a predetermined position without being worn. Moreover, the brain-wave acquiring unit 11, the brain wave decoder 12, the processing unit 16, the display control unit 17, the display unit 18, and the communication unit 19 may be arranged in an integrated unit, or may be arranged separately.

The brain-wave acquiring unit 11 is to acquire brain waves, which are brain information of the user. The brain-wave acquiring unit 11 includes an electric sensor (for example, electrode) that detects, for example, brain waves obtained from weak electric currents flowing in a neural network of the brain. The brain-wave acquiring unit 11 detects a potential of a weak electric current (electrical signal) based on thoughts of the user including contemplation and the like or when the user receives a stimulus from an external environment. The brain-information acquiring unit is not limited to the brain-wave acquiring unit 11. The brain-information acquiring unit may be, for example, one that acquires blood flow due to brain activity, which is brain information of a user, by near-infrared light measurement or the like. The brain-wave acquiring unit 11 is connected to the brain wave decoder 12, and transmits brain waves, which are brain information, acquired from the user to the brain wave decoder 12.

The brain wave decoder 12 restores an electrical signal of the brain waves of the user acquired by the brain-wave acquiring unit 11 to thought information of the user. In this case, multiple electrical signals of brain waves of the user and thought information of the user are associated with each other in advance. In this case, for example, electrical signals of brain waves and thought information of a user are associated by using machine learning, such as deep learning.

The start command buffer 13 temporarily stores a first command determined by a determining unit 21 based on the thought information of the user. The first command is a command for preparing to start acceptance of a second command (execution command) to activate the operation object 50, and is, for example, a command, such as “start operating the robot” or “start inputting the execution command”. The start command buffer 13 can transmit and receive various kinds of data between itself and the processing unit 16.

The execution command buffer 14 temporarily stores a second command determined by the determining unit 21 based on the thought information of the user. The second command is an execution command to activate the operation object 50, and is a command, such as “move forward”, “move backward”, “stop”, “speed up”, “speed down”, “turn right”, and “turn left”. In this case, the second commands and actions of the operation object 50 are associated with each other in advance. The execution command buffer 14 can transmit and receive various kinds of data between itself and the processing unit 16.

The second command is not limited to a concept indicating an instructed action, and may be one supplemented with a numerical value or the like complementing a concept indicating an instructed action. For example, the brain wave decoder 12 may detect the strength of a brainwave as a decimal value ranging from 0 to 1 while restoring thought information of the user based on an electrical signal acquired by brain-wave acquiring unit 11, to set the second command adding the strength (numerical value) to the thought information of the user. In this case, the numerical value of the second command is a calculation of the maximum value of torque output of the driving device equipped in the operation object 50.

Moreover, the first command (start command) and the second command (execution command) may be set associating with each other. That is, the first command may be set as a single common command for different types of the second command. For example, for “move forward” and “move backward”, which are the second commands, “start” or “start operation” is set as the first command. Alternatively, individual first commands may be set separately for different types of the second commands. For example, for “move forward” and “speed up”, which are the second commands, “start moving” is set as the first command, and for “stretch” and “grab”, which are the second commands, “start arm operation” is set as the first command. Moreover, by setting an individual first command for each of the second commands, “move forward”, “move backward”, “stop”, “speed up”, “speed down”, “turn right”, and “turn left”, it is possible to avoid a situation of issuing the next second command inadvertently due to excessive momentum.

The storage unit 15 stores the multiple first commands (start commands) and the multiple second commands (execution commands). Moreover, the storage unit 15 may store training data obtained by training with the correlation between brainwave electrical signals and thought information of the user using machine learning. The second commands are associated with the first commands in advance.

The start command buffer 13 and the execution command buffer 14 are recording units, such as a semiconductor memory device including a random access memory (RAM) equipped in the processing unit 16, a flash memory, and the like. The storage unit 15 is constituted of a memory card, a solid state drive (SSD), an external storage device, and the like.

The processing unit 16 is an arithmetic processing device (control device) that is constituted of, for example, a central processing unit (CPU) or the like. The processing unit 16 loads a stored program to a memory, and executes a command included in the program. The processing unit 16 includes an internal memory not illustrated, and the internal memory is used for temporary storage of data in the processing unit 16. The processing unit 16 includes the determining unit 21, an executing unit 22, and a receiving unit 23 as its functions. Moreover, the processing unit 16 transmits processing results to the display control unit 17 and the communication unit 19.

The determining unit 21 determines whether the thought information of the user acquired by the brain-wave acquiring unit 11 and restored by the brain wave decoder 12 is a brain wave corresponding to two different commands of the first command and the second command.

Specifically, the determining unit 21 compares the thought information of the user restored by the brain wave decoder 12 and the first command (start command) stored in the storage unit 15. At this time, the determining unit 21 determines that the thought information of the user is the first command when the thought information matches the first command, and the determining unit 21 stores the command determined as the first command in the start command buffer 13. On the other hand, the determining unit 21 determines that the thought information of the user is not the first command when the thought information of the user does not match the first command. In this case, the determining unit 21 does not store the command determined that it is not the first command in the start command buffer 13. In the determination of a match between the thought information of the user restored by the brain wave decoder 12 and the first command by the determining unit 21, it is determined as a match when it is possible to determine that the thought information of the user signifies the first command, even if it is not a complete match.

Furthermore, the determining unit 21 compares the thought information of the user restored by the brain wave decoder 12 and the second command (execution command) stored in the storage unit 15. At this time, the determining unit 21 determines that the thought information of the user is the second command when the thought information of the user matches the second command. The determining unit 21 stores the second command in the execution command buffer 14 when the thought information of the user is determined as the second command. On the other hand, the determining unit 21 determines that the thought information of the user is not the second command when the thought information of the user does not match the second command stored in the storage unit 15. The determining unit 21 does not store the second command in the execution command buffer 14 when it is determined that the thought information of the user is not the second command.

At this time, the determining unit 21 determines that the thought information of the user is brain information corresponding to the first command when a matching rate between the thought information of the user restored by the brain wave decoder 12 and a first-command threshold value (start-command threshold value) stored in the storage unit 15 is equal to or higher than a first matching rate (for example, 80%) set in advance. Meanwhile, the determining unit 21 determines that the thought information of the user is brain information corresponding to the first command when a matching rate between the thought information of the user restored by the brain wave decoder 12 and a second-command threshold value (execution-command threshold value) stored in the storage unit 15 is equal to or higher than a second matching rate (for example, 90%) set in advance. The second matching rate is set to be higher than the first matching rate.

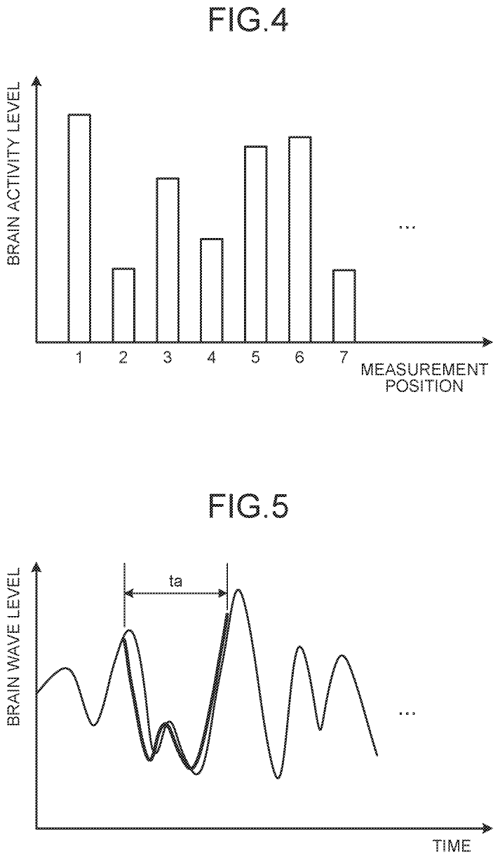

FIG. 4 is a graph representing brain activity levels corresponding to measurement positions in a brain, and FIG. 5 is a graph representing temporal changes of a brain wave at a specific measurement position in the brain.

FIG. 4 represents brain activity levels at multiple different measurement positions in the brain. By comparing a brain activity level at each measurement position with a predetermined brain-activity-level threshold value, the first matching rate between the thought information of the user and the first command, or the second matching rate between the thought information of the user and the second command are obtained.

FIG. 5 represents temporal changes of a brain wave level at a specific measurement position. By comparing temporal changes of a brain wave during predetermined time ta and a brain-wave threshold value (bold line in FIG. 5) set in advance, the first matching rate between the thought information of the user and the first command and the second matching rate between the thought information of the user and the second command are obtained.

By comparing a brain activity level of the user at each measurement position and a brain-activity-level threshold value, and by comparing temporal changes of a brain wave and a brain-wave threshold value, the first matching rate between the thought information of the user and the first command, or the thought information of the user and the second matching rate may be obtained.

Moreover, when the first command (start command) and the second command (execution command) are associated, the determining unit 21 determines whether the first command (start command) stored in the start command buffer 13 and the second command (execution command) stored in the execution command buffer 14 have associated relationship.

The executing unit 22 executes processing corresponding to the second command when the determining unit 21 determines that brain wave corresponding to the first command and brain wave corresponding to the second command are acquired. Specifically, the executing unit 22 executes the processing corresponding to the second command when it is determined that thought information of the user acquired first is the first command by the determining unit 21, it is determined that thought information of the user acquired next is the second command by the determining unit 21.

However, the executing unit 22 cancels the acquired first command when predetermined waiting time, for example, three seconds, has passed since the determining unit 21 determines acquisition of the first command. Moreover, the executing unit 22 cancels the acquired first command when the processing unit 16 acquires a cancel command as thought of the user after the determining unit 21 determines acquisition of the first command. The cancel command is preset, and an electrical signal of a brain wave of the user and thought information of the user (cancel command) are associated in advance, and stored in the storage unit 15. The cancel command is, for example, a symbol or a concept different from the first command, such as “x” and “cancel”.

The receiving unit 23 is capable of receiving a processing signal from the operation object 50. That is, to execute processing corresponding to the second command, the executing unit 22 transmits a first processing signal corresponding to the second command (execution command) to the operation object 50 by the communication unit 19. In this case, for example, when the operation object 50 cannot perform the processing corresponding to the second command, the operation object 50 transmits a second processing signal indicating that the processing corresponding to the second command cannot be executed to the processing unit 16 by the communication unit 19. The receiving unit 23 receives the second processing signal from the operation object 50.

For example, when the second command is “move forward” and there is a wall ahead of the operation object 50, the operation object 50 cannot “move forward” because the wall is obstructing. In this case, the operation object 50 transmits the second processing signal indicating that it cannot “move forward” to the processing unit 16, and the receiving unit 23 receives it. When there is a removable obstacle ahead of the operation object 50, the operation object 50 may transmit the second processing signal indicating “please remove the obstacle” to the processing unit 16. The same applies for the cases in which the second command is “move backward”, “turn right”, “turn left”, and the like. Furthermore, the operation object 50 may also transmit the second processing signal indicating “please charge the battery” when it cannot operate because the battery storage is insufficient.

The second processing signal received by the receiving unit 23 may be converted into an electrical signal of a brain wave by a not illustrated brain wave encoder, and may be delivered to the user as thought information through a not illustrated brain-wave restoring unit. A presentation method of presenting various kinds of information to the user as the second processing signal received by the receiving unit 23 is not limited to presentation by brain waves and, for example, it may be displayed on the display unit 18.

To the display control unit 17, the display unit 18 is connected. The display control unit 17 transmits a processing result transmitted from the processing unit 16 to the display unit 18, to display it. The display control unit 17 displays an operation state of the operation control device 10, which is the processing result of the processing unit 16, or a thought instruction to the user on the display unit 18.

The display unit 18 displays the operation state of the operation control device 10 and a thought instruction to the user transmitted from the display control unit 17. The display unit 18 presents necessary information to the user. The display unit 18 is, for example, a display including a liquid crystal display (LCD), an organic electroluminescence (EL) display, or the like.

The communication unit 19 is capable of wireless communication with the operation object 50. The communication unit 19 transmits processing information processed by the processing unit 16 to the operation object 50. Specifically, when the determining unit 21 determines that a brain wave corresponding to the first command and a brain wave corresponding to the second command are acquired, the executing unit 22 generates a control signal (first processing signal) corresponding to processing of the second command to send to the communication unit 19. The communication unit 19 transmits the control signal corresponding to the processing of the second command to the operation object 50. Receiving the second command transmitted by the communication unit 19, the operation object 50 operates according to the processing of the second command.

The communication unit 19 transmits processing information (second processing signal) indicating a processing state of the operation object 50 to the processing unit 16. Specifically, when the operation object 50 cannot execute the processing of the second command, the operation object 50 generates a control signal (second processing signal) corresponding to a content indicating that the processing of the second command cannot be performed, and transmits it to the communication unit 19. The communication unit 19 transmits the control signal corresponding to the content indicating that the processing of the second command cannot be executed to the processing unit 16. The receiving unit 23 receives the control signal corresponding to the content indicating that the processing of the second command cannot be executed that is transmitted by the communication unit 19.

The first notifying unit 31 notifies the external that the processing unit 16 is in process. Specifically, the first notifying unit 31 notifies that the first processing signal is being processed to surroundings of the user or the operation object 50 while the processing unit 16 is transmitting the first processing signal corresponding to the second command (execution command) to the operation object 50. Moreover, the first notifying unit 31 notifies that the second processing signal is being processed to surroundings of the user or the operation object 50 while the processing unit 16 is receiving the second processing signal from the operation object 50. Furthermore, the first notifying unit 31 may notify that respective processing signals are being processed to surroundings of the user or the operation object 50 after the determining unit 21 has performed determination of the first command (start command). The first notifying unit 31 is only required to be capable of notifying that at least either one of the first processing signal and the second processing signal is being processed to surroundings of the user or the operation object 50. Moreover, the first notifying unit 31 is only required to notify that the first processing signal and the second processing signal are being processed to surroundings of at least either one of the user and the operation object 50.

The first notifying unit 31 is, for example, a display including a liquid crystal display, an organic EL display, or the like. In this case, the first notifying unit 31 may also serve as the display unit 18. Moreover, the first notifying unit 31 may be a visual representation device, such as an illumination, other than the display, or may be an auditory acoustic device, such as a speaker. The first notifying unit 31 may be mounted on the user or the operation object 50, or may be arranged near the user or the operation object 50. In this case, the first notifying unit 31 may be configured to differ the notification method to the surroundings of the user or the operation object 50 between a case in which the processing unit 16 is transmitting the first processing signal corresponding to the second command to the operation object 50 and a case in which the processing unit 16 is receiving the second processing signal from the operation object 50.

### Operation Control Method

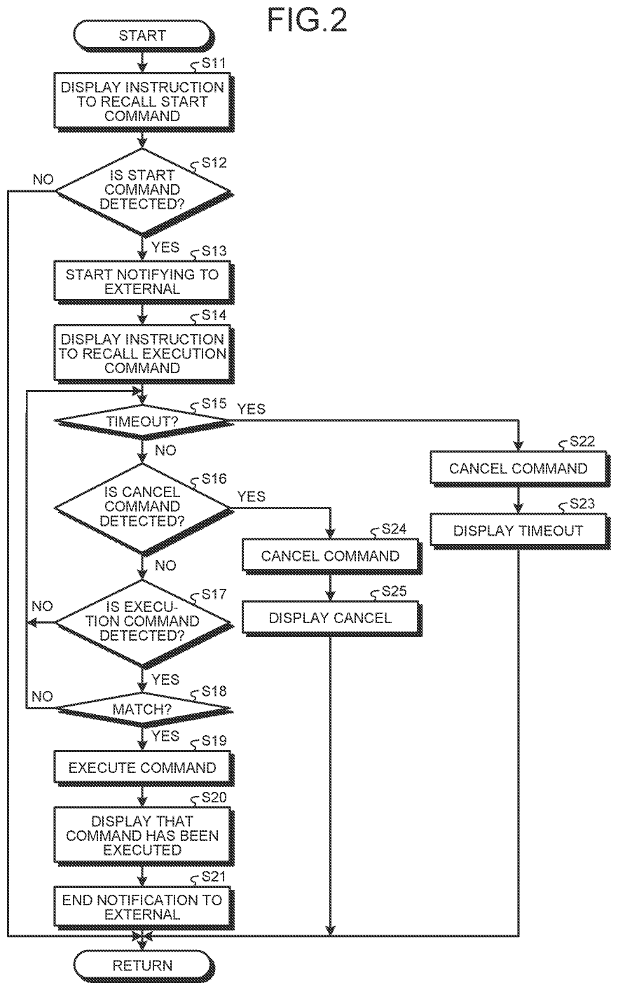

An operation control method performed by the operation control device 10 will be explained. FIG. 2 is a flowchart illustrating a flow of transmission processing of the operation control device according to the first embodiment.

As illustrated in FIG. 1 and FIG. 2, at step S11, the processing unit 16 controls the display control unit 17, to cause the display unit 18 to display an instruction to recall the first command (start command) to the user. The display control unit 17 displays a message instructing to recall the first command representing an operation, such as “please recall the start command”, on the display unit 18.

At step S12, the determining unit 21 determines whether the thought information of the user acquired by the brain-wave acquiring unit 11 and restored by the brain wave decoder 12 is a brain wave corresponding to the first command (start command). The determining unit 21 compares the thought information of the user restored by the brain wave decoder 12 and the first command stored in the storage unit 15, and exits this routine if it is determined that the thought information of the user does not match the first command, that is, when a matching rate between two is lower than the first matching rate (for example, 80%) (NO), determining that the thought information of the user is not the first command. On the other hand, the determining unit 21 determines the thought information of the user as the first command when it is determined that the thought information of the user matches the first command stored in the storage unit 15, that is, when a matching rate between two is equal to or higher than the first matching rate (for example, 80%) (YES), and the determining unit 21 stores the first command in the start command buffer 13, and shifts to step S13.

At step S13, the notifying unit 31 notifies that the processing unit 16 is in process to the external. Specifically, the first notifying unit 31 notifies various kinds of information to surroundings of the user or the operation object 50 when the determining unit 21 determines that the thought information of the user is the first command (start command) and the second command (execution command) is being accepted. The processing unit 16 notifies that the user is recalling the second command (execution command) to the user or the operation object 50 by the first notifying unit 31. The first notifying unit 31 notifies a message indicating the processing being processed, such as “recalling the execution command”. At this time, because the first notifying unit 31 enables people around to identify a state of the user, it becomes easy for the user to recall the execution command.

At step S14, the processing unit 16 displays an instruction to recall the second command (execution command) on the display unit 18 to the user by controlling the display control unit 17. The display control unit 17 displays a message instructing to recall the second command representing an operation, such as “please recall the execution command”, on the display unit 18.

At step S15, the processing unit 16 determines whether a timeout has occurred as predetermined waiting time has passed since the determining unit 21 determines acquisition of the first command. When it is determined that a timeout has occurred (YES), the processing unit 16 cancels the acquired first command at step S22. At step S23, the processing unit 16 displays that the first command is canceled on the display unit 18 to the user by controlling the display control unit 17. The display control unit 17 displays a message indicating timeout, such as “it has timed out”, on the display unit 18.

When it is determined that a timeout has not occurred (NO), the processing unit 16 determines whether a brain wave corresponding to the cancel command is detected at step S16. When it is determined that a brain wave corresponding to the cancel command is detected (YES), the processing unit 16 cancels the acquired first command at step S24. At step S25, the processing unit 16 displays that the first command is canceled on the display unit 18 to the user by controlling the display control unit 17. The display control unit 17 displays a message indicating that the first command is canceled, such as “the first command is canceled”, on the display unit 18.

On the other hand, when the processing unit 16 determines that a brain wave corresponding to the cancel command is not detected (NO), the determining unit 21 determines whether a brain wave corresponding to the second command (execution command) is detected at step S17. The determining unit 21 compares the thought information of the user restored by the brain wave decoder 12 and the second command stored in the storage unit 15, and returns, when it is determined that the thought information of the user does not match the second command, that is, when a matching rate between two is lower than the second matching rate (for example, 90%) (NO), to step S15 and continues the processing.

On the other hand, when it is determined that the thought information of the user matches the second command stored in the storage unit 15, that is, when a matching rate between two is equal to or higher than the second matching rate (for example, 90%) (YES), the determining unit 21 determines the thought information of the user as the second command, and stores the determined second command in the execution command buffer 14. Furthermore, at step S18, the determining unit 21 determines whether the first command determined at step S12 and stored in the start command buffer 13, and the second command determined at step S17 and stored in the execution command buffer 14 are the first command and the second command, the relevance of which is associated in advance. When the determining unit 21 determines that the first command and the second command are not associated (NO), it returns to step S15. When the determining unit 21 determines that the first command and the second command are associated (YES), it shifts to step S19.

At step S19, the executing unit 22 executes processing corresponding to the second command. That is, the executing unit 22 transmits a control signal corresponding to the processing of the second command to the operation object 50 by the communication unit 19, to actuate the operation object 50. At step S20, the processing unit 16 displays that the second command has been executed on the display unit 18 to the user by controlling the display control unit 17. The display control unit 17 displays a message indicating that the first command has been executed, such as “the speed-up command is executed” on the display unit 18. Moreover, the processing unit 16 notifies that the first command (execution command) is executed by the operation object 50 to the user and the operation object 50 by the first notifying unit 31. The first notifying unit 31 notifies a message representing an operation, such as “the robot is activated”. At step S21, the first notifying unit 31 ends notification to the external.

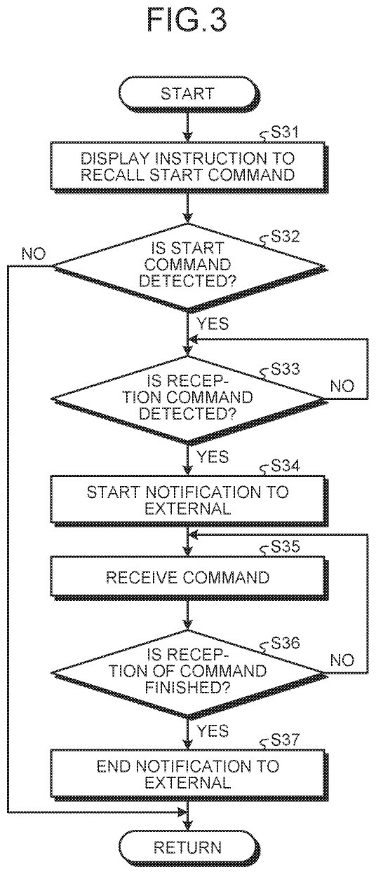

FIG. 3 is a flowchart illustrating a flow of reception processing of the operation control device according to the first embodiment.

As illustrated in FIG. 1 and FIG. 3, the processing unit 16 controls the display control unit 17 at step S31, to display an instruction to recall the first command (start command) on the display unit 18 to the user. The display control unit 17 displays, for example, a message instructing to recall the first command representing an operation, such as “please recall the start command” on the display unit 18.

At step S32, the determining unit 21 determines whether thought information acquired by the brain-wave acquiring unit 11 and restored by the brain wave decoder 12 is a brain wave corresponding to the first command (start command). The determining unit 21 compares the thought information of the user restored by the brain wave decoder 12 and the first command stored in the storage unit 15, and exits this routine when it is determined that the thought information of the user does not match the first command, that is, when a matching rate of two is lower than the first matching rate (for example, 80%) (NO), determining that the thought information of the user is not the first command. On the other hand, the determining unit 21 stores the first command in the start command buffer 13 when it is determined that the thought information of the user matches the first command stored in the storage unit 15, that is, when the matching rate of two is equal to or higher than the first matching rate (for example, 80%) (YES), determining that the thought information of the user is the first command, and shifts to step S33.

At step S33, the determining unit 21 determines whether a reception command is received from the operation object 50. The determining unit 21 compares, for example, the received reception command and the reception command stored in the storage unit 15, and exits this routine when the two do not match each other (NO). On the other hand, the determining unit 21 compares the received reception command and the reception command stored in the storage unit 15, and shifts to step S34 when it is determined that the two match each other (YES).

At step S34, the first notifying unit 31 notifies that the processing unit 16 is in process to the external. Specifically, the first notifying unit 31 notifies various kinds of information to surroundings of the user and the operation object 50 when the receiving unit 23 receives the reception command from the operation object 50. The processing unit 16 notifies that the reception command is being received from the operation object 50 by the first notifying unit 31, for example, to the user or the operation object 50. The first notifying unit 31 notifies a message representing the processing being processed, such as “receiving from the operation object 50”.

At step S35, the receiving unit 23 receives the reception command from the operation object 50, and presents the received content to the user. At step S36, the receiving unit 23 determines whether reception of the reception command from the operation object 50 has been finished. The receiving unit 23 continues the processing at step S35 when it is determined that reception of the reception command from the operation object 50 has not been finished (NO). On the other hand, when the receiving unit 23 determines that the reception command from the operation object 50 has been finished (YES), the first notifying unit 31 ends the notification to the external at step S37.

In the explanation described above, when the first command (start command) and the reception command are detected, the first notifying unit 31 notifies of it to the external, but the processing at step S32 may be omitted. That is, the determining unit 21 may be configured to notify of it to the external when the reception command is detected, even if the first command (start command) has not been detected yet.

### Second Embodiment

### Operation Control Device

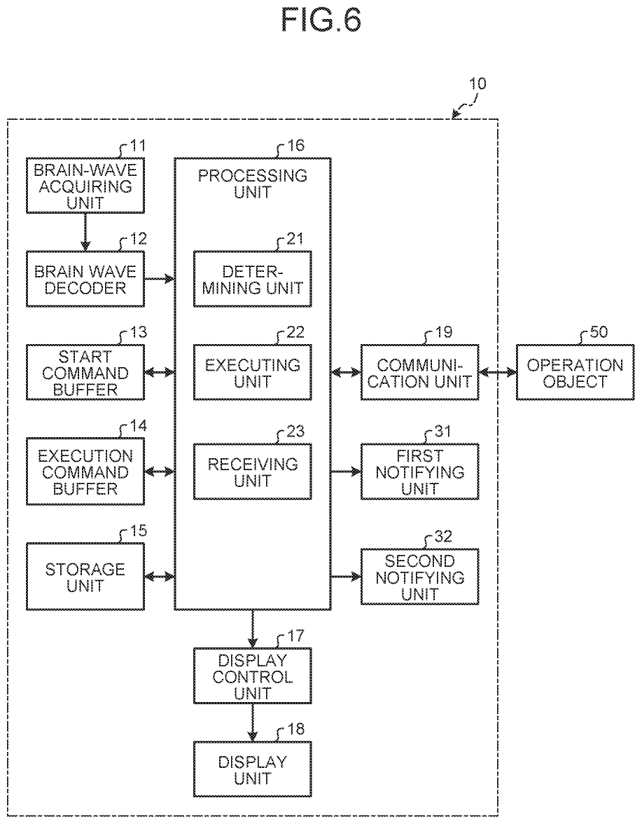

FIG. 6 is a block diagram illustrating a configuration example of an operation control device according to a second embodiment. Identical reference symbols are assigned to components having similar functions as the first embodiment described above, and detailed explanation thereof is omitted.

In the second embodiment, as illustrated in FIG. 6, the operation control device 10 is to control operation of the operation object 50 based on brain information of a user. The operation control device 10 includes the brain-wave acquiring unit (brain-information acquiring unit) 11, the brain wave decoder 12, the start command buffer 13, the execution command buffer 14, the storage unit 15, the processing unit 16, the display control unit 17, the display unit 18, the communication unit 19, the first notifying unit 31, and a second notifying unit 32.

The brain-wave acquiring unit 11, the brain wave decoder 12, the start command buffer 13, the execution command buffer 14, the storage unit 15, the processing unit 16, the display control unit 17, the display unit 18, the communication unit 19, and the first notifying unit 31 are similar to those of the first embodiment, and explanation thereof is omitted.

The second notifying unit 32 notifies that the processing unit 16 is in process to the user. Specifically, the second notifying unit 32 notifies to the user that the first processing signal is being processed while the processing unit 16 is transmitting the first processing signal corresponding to the second command (execution command) to the operation object 50. Moreover, the second notifying unit 32 notifies to the user that the second processing signal is being processed while the processing unit 16 is receiving the second processing signal from the operation object 50. Furthermore, the second notifying unit 32 may notify to the user that various kinds of processing signals are being processed after the determining unit 21 performs determination of the first command (start command). The second notifying unit 32 is only required to be capable of notifying that at least one of the first processing signal and the second processing signal is being processed to the user.

The second notifying unit 32 is, for example, a display including a liquid crystal display or an organic EL display. In this case, the second notifying unit 32 may be configured to serve as the display unit 18 also. Moreover, the second notifying unit 32 may be a visual representation device, such as an illumination, other than the display, or may be an auditory acoustic device, such as a speaker, a headphone, and an earphone. Furthermore, the second notifying unit 32 may be configured such that a user is notified through the tactile sense. The second notifying unit 32 is only required to enable the user to be notified through senses, such as vision, hearing, and touch, and may be mounted on the user, or may be arranged near the user. In this case, the second notifying unit 32 may be configured to differ the notification method to the surroundings of the user or the operation object 50 between a case in which the processing unit 16 is transmitting the first processing signal corresponding to the second command to the operation object 50 and a case in which the processing unit 16 is receiving the second processing signal from the operation object 50.

### Operation Control Method

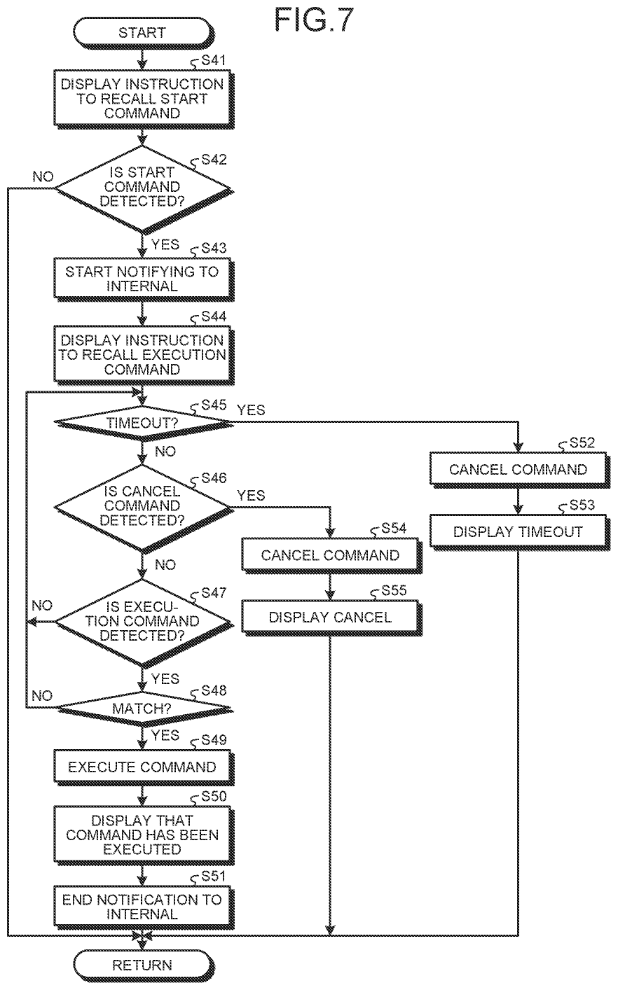

An operation control method performed by the operation control device 10 will be explained. FIG. 7 is a flowchart illustrating a flow of transmission processing of the operation control device according to the second embodiment. Actions of the first notifying unit 31 are similar to those of the first embodiment and, therefore, explanation thereof is omitted.

As illustrated in FIG. 6 and FIG. 7, at step S41, the processing unit 16 controls the display control unit 17, to cause the display unit 18 to display an instruction to recall the first command (start command) to the user. The display control unit 17 displays a message instructing to recall the first command representing an operation, such as “please recall the start command”, on the display unit 18.

At step S42, the determining unit 21 determines whether the thought information of the user acquired by the brain-wave acquiring unit 11 and restored by the brain wave decoder 12 is a brain wave corresponding to the first command (start command). The determining unit 21 compares the thought information of the user restored by the brain wave decoder 12 and the first command stored in the storage unit 15, and exits this routine if it is determined that the thought information of the user does not match the first command, that is, when a matching rate between two is lower than the first matching rate (for example, 80%) (NO), determining that the thought information of the user is not the first command. On the other hand, the determining unit 21 determines the thought information of the user as the first command when it is determined that the thought information of the user matches the first command stored in the storage unit 15, that is, when the matching rate between two is equal to or higher than the first matching rate (for example, 80%) (YES), and the determining unit 21 stores the first command in the start command buffer 13, and shifts to step S13.

At step S43, the second notifying unit 32 notifies that the processing unit 16 is in process to the internal. Specifically, the second notifying unit 32 notifies various kinds of information to the user when the determining unit 21 determines that the thought information of the user is the first command (start command) and the second command (execution command) is being accepted. The processing unit 16 notifies, for example, that a recall of the second command (execution command) is being accepted from the user by the second notifying unit 32 to the user. The second notifying unit 32 notifies, for example, a message representing the processing being processed, such as “recall of the execution command is being accepted”. At this time, the second notifying unit 32 may limit the vision of the user by darkening the surroundings or dimming the display. Moreover, the second notifying unit 32 may limit auditory perception of the user by making surrounding sounds less audible or reducing the volume of the speaker. Due to restrictions on visual and auditory capabilities, it becomes easier for the user to recall the execution command.

At step S44, the processing unit 16 displays an instruction to recall the second command (execution command) on the display unit 18 to the user by controlling the display control unit 17. The display control unit 17 displays a message instructing to recall the second command representing an operation, such as “please recall the execution command”, on the display unit 18.

At step S45, the processing unit 16 determines whether a timeout has occurred as predetermined waiting time has passed since the determining unit 21 determines acquisition of the first command. When it is determined that a timeout has occurred (YES), the processing unit 16 cancels the acquired first command at step S52. At step S53, the processing unit 16 displays that the first command is canceled on the display unit 18 to the user by controlling the display control unit 17. The display control unit 17 displays a message indicating timeout, such as “it has timed out”, on the display unit 18.

When it is determined that a timeout has not occurred (NO), the processing unit 16 determines whether a brain wave corresponding to the cancel command is detected at step S46. When it is determined that a brain wave corresponding to the cancel command is detected (YES), the processing unit 16 cancels the acquired first command at step S54. At step S55, the processing unit 16 displays that the first command is canceled on the display unit 18 to the user by controlling the display control unit 17. The display control unit 17 displays a message indicating that the first command is canceled, such as “the first command is canceled”, on the display unit 18.

On the other hand, when it is determined that a brain wave corresponding to the cancel command is not detected (NO), the processing unit 16 determines whether a brain wave corresponding to the second command (execution command) is detected at step S47. The determining unit 21 compares the thought information of the user restored by the brain wave decoder 12 and the second command stored in the storage unit 15, and returns, when it is determined that the thought information of the user does not match the second command, that is, when a matching rate between two is lower than the second matching rate (for example, 90%) (NO), to step S45 and continues the processing.

On the other hand, when it is determined that the thought information of the user matches the second command stored in the storage unit 15, that is, when the matching rate between two is equal to or higher than the second matching rate (for example, 90%) (YES), the determining unit 21 determines the thought information of the user as the second command, and stores the determined second command in the execution command buffer 14. Furthermore, at step S48, the determining unit 21 determines whether the first command determined at step S42 and stored in the start command buffer 13, the second command determined at step S47 and stored in the execution command buffer 14 are the first command and the second command, the relevance of which is associated in advance. When the determining unit 21 determines that the first command and the second command are not associated (NO), it returns to step S45. When the determining unit 21 determines that the first command and the second command are associated (YES), it shifts to step S49.

At step S49, the executing unit 22 executes processing corresponding to the second command. That is, the executing unit 22 transmits a control signal corresponding to the processing of the second command to the operation object 50 by the communication unit 19, to actuate the operation object 50. At step S50, the processing unit 16 displays that the second command has been executed on the display unit 18 to the user by controlling the display control unit 17. The display control unit 17 displays a message indicating that the first command has been executed, such as “the speed-up command has been executed”, on the display unit 18. Moreover, the processing unit 16 notifies to the user or the operation object 50 that the operation object 50 is going to execute the first command (execution command) by the second notifying unit 32. The second notifying unit 32 notifies, for example, a message indicating an operation, such as “the robot is going to operate”. At step S51, the second notifying unit 32 ends the notification to the internal.

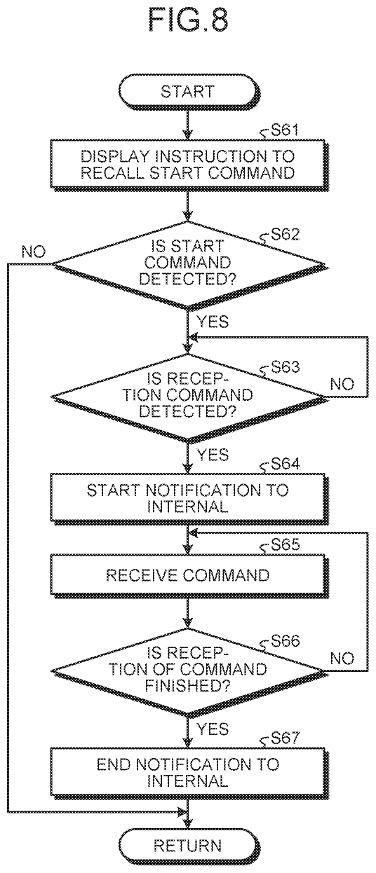

FIG. 8 is a flowchart illustrating a flow of reception processing of the operation control device according to the second embodiment.

As illustrated in FIG. 6 and FIG. 8, at step S61, the processing unit 16 controls the display control unit 17, to display an instruction to recall the first command (start command) on the display unit 18 to the user. The display control unit 17 displays, for example, a message instructing to recall the first command representing an operation, such as “please recall a start command”, on the display unit 18.

At step S62, the determining unit 21 determines whether thought information of the user acquired by the brain-wave acquiring unit 11 and restored by the brain wave decoder 12 is a brain wave corresponding to the first command (start command). The determining unit 21 compares the thought information of the user restored by the brain wave decoder 12 and the first command stored in the storage unit 15, and exits this routine when it is determined that the thought information of the user does not match the first command, that is, when a matching rate between two is lower than the first matching rate (for example, 80%) (NO), determining that the thought information of the user is not the first command. On the other hand, the determining unit 21 stores the first command in the start command buffer 13 when it is determined that the thought information of the user matches the first command stored in the storage unit 15, that is, when the matching rate between two is equal to or higher than the first matching rate (for example, 80%) (YES), determining that the thought information of the user is the first command, and shifts to step S63.

At step S63, the determining unit 21 determines whether the reception command is received from the operation object 50. The determining unit 21 compares the received reception command and the reception command stored in the storage unit 15, and exits this routine when it is determined that the two do not match each other (NO). On the other hand, the determining unit 21 compares the received reception command and the reception command stored in the storage unit 15, and shifts to step S64 when it is determined that the two match each other (YES).

At step S64, the second notifying unit 32 notifies that the processing unit 16 is in process to the internal. Specifically, the second notifying unit 32 notifies various kinds of information to the user when the receiving unit 23 receives the reception command from the operation object 50. The processing unit 16 notifies, for example, that the reception command is being received from the operation object 50 to the user. The second notifying unit 32 notifies, for example, a message indicating the processing being processed, such as “receiving from the operation object 50”.

At step S65, the receiving unit 23 receives the reception command from the operation object 50, and at step S66, the receiving unit 23 determines whether reception of the reception command from the operation object 50 has been finished. The receiving unit 23 continues the processing at step S65 when it is determined that the reception of the reception signal from the operation object 50 has not been finished (NO). On the other hand, the receiving unit 23 ends the notification to the internal at step S67 when it is determined that the reception of the reception signal from the operation object 50 has been finished (YES).

In the present embodiment, the brain-wave acquiring unit (brain-information acquiring unit) 11 that acquires brain information of a user, the determining unit 21 that determines whether brain information acquired by the brain-wave acquiring unit 11 is brain information corresponding to the execution command representing an operation to operate the operation object 50, the executing unit 22 that executes processing corresponding to the execution command when the determining unit 21 determines that brain information corresponding to the execution command is acquired, and the first notifying unit 31 that notifies to surroundings of at least one of the user and the operation object 50 that the first processing signal or the second processing signal is being processed while the first processing signal corresponding to the execution command is being transmitted to the operation object 50 or the second processing signal from the operation object 50 is being received are included.

Therefore, it is possible to notify of a recalling state of a user or an action state of a robot to surroundings of the user or the operation object 50 by a notification content of the first notifying unit 31, people around can determine a state of the user or predict an action of the robot, and it is possible to prevent a recall of an unintended command issued by the user as a result of people around touching the robot or talking to the user. As a result, when the user is executing transmission or reception of a command, by notifying the state to the external, it is possible to ensure the safety in execution of brainwave commands.

Moreover, in the present embodiment, the determining unit 21 determines whether brain information acquired by the brain-wave acquiring unit 11 is brain information corresponding to the start command indicating readiness to accept the execution command, and the first notifying unit 31 notifies of that processing is in progress when the determining unit 21 determines that brain information corresponding to the start command is acquired. Therefore, thinking time is provided from recalling the start command to recalling the execution command, enabling the user to recall an appropriate execution command without fail.

Furthermore, in the present embodiment, the determining unit 21 determines that it is brain information corresponding to the start command when a matching rate between the brain information acquired by the brain-wave acquiring unit 11 and brain information of the start-command threshold value is equal to or higher than the first matching rate set in advance, and determines that the brain information is the execution command when the matching rate between the brain information acquired by the brain-wave acquiring unit 11 and brain information of the execution-command threshold value is equal to or higher than the second matching rate that is higher than the first matching rate. Therefore, by setting a determination level for the matching rate of the start command to a low level, difference among individuals in determination of the start command can be solved, and standardization of commands is enabled so that the program can be simplified.

In the present embodiment, the brain-wave acquiring unit (brain-information acquiring unit) 11 that acquires brain information of a user, the determining unit 21 that determines whether brain information acquired by the brain-wave acquiring unit 11 is brain information corresponding to an execution command representing an operation to operate the operation object 50, the executing unit 22 that executes processing corresponding to the execution command when the determining unit 21 determines that brain information corresponding to the execution command is acquired, and the second notifying unit 32 that notifies that the first processing signal or the second processing signal is being processed to the user when the first processing signal corresponding to the execution command is being transmitted to the operation object 50 or the second processing signal from the operation object 50 is being received are included.

Therefore, it is possible to notify of a recalling state of a user or an action state of a robot to the user by a notification content of the second notifying unit 32, the user can be aware of a processing state of the determining unit 21 and the executing unit 22, and it is possible to prevent a recall of an unintended command by the user. As a result, when the user is executing transmission or reception of a command, by notifying the state to the internal, it is possible to ensure the safety in execution of brainwave commands.

Moreover, in the present embodiment, the determining unit 21 determines whether brain information acquired by the brain-wave acquiring unit 11 is brain information corresponding to the start command representing readiness to accept the execution command, and the second notifying unit 32 notifies that processing is in progress when the determining unit 21 determines that the brain information corresponding to the start command is acquired. Therefore, thinking time is provided from recalling the start command to recalling the execution command, enabling the user to recall an appropriate execution command without fail.

In the embodiment described above, it is configured to accept the execution command when brain information acquired by the brain-wave acquiring unit 11 is determined as brain information corresponding to the start command, but it may also be configured to end to accept the execution command when brain information acquired by the brain-wave acquiring unit 11 is determined as brain information corresponding to an end command.

The operation control device 10 according to the present invention has so far been explained, but other than the embodiments described above, it may be implemented in various different embodiments.

The illustrated respective components of the operation control device 10 are of functional concept, and it is not necessarily required to be configured physically as illustrated. That is, specific forms of the respective devices are not limited to the ones illustrated, and all or some thereof can be configured to be distributed or integrated functionally or physically in arbitrary units according to various kinds of processing loads, usage conditions, and the like of the respective devices.

The configuration of the operation control device 10 is implemented, for example, by a program loaded on a memory or the like as software. In the embodiment described above, it is explained as functional blocks implemented by coordination of the hardware or software. That is, these functional blocks can be implemented by various forms only by hardware, only by software, or by a combination of those.

The components described above include those easily conceivable by a person skilled in the art, and those practically the same. Furthermore, the components described above can be combined as appropriate. Moreover, various omissions, replacements, and alterations of configurations are possible within a range not departing from a gist of the present invention.

The operation control device, the operation control method, and the computer program of the present disclosure are applicable to, for example, a brain machine interface.

The computer program for implementing the operation control method according to the present disclosure may be provided by being stored in a non-transitory computer-readable storage medium, or may be provided via a network such as the Internet. Examples of the computer-readable storage medium include optical discs such as a digital versatile disc (DVD) and a compact disc (CD), and other types of storage devices such as a hard disk and a semiconductor memory.

According to the present disclosure, by notifying the external of its state when a user is executing transmission and reception of a command, safety of brain wave command execution can be ensured.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An operation control device comprising:
a brain-information acquiring unit configured to acquire brain information of a user;
a determining unit configured to determine whether the brain information acquired by the brain-information acquiring unit is brain information corresponding to an execution command representing an operation to operate an operation object;
an executing unit configured to execute processing corresponding to the execution command when the determining unit determines that brain information corresponding to the execution command is acquired; and
at least one of:
a first notifying unit configured to notify, when a first processing signal corresponding to the execution command is being transmitted to the operation object or when a second processing signal from the operation object is being received, surroundings of at least one of the user and the operation object that the first processing signal or the second processing signal is being processed, and
a second notifying unit configured to notify, when a first processing signal corresponding to the execution command is being transmitted to the operation object or when a second processing signal from the operation object is being received, the user that the first processing signal or the second processing signal is being processed.

2. The operation control device according to claim 1, wherein
the determining unit is configured to determine whether the brain information acquired by the brain-information acquiring unit is brain information corresponding to a start command representing readiness to accept the execution command, and
the first notifying unit and the second notifying unit is each configured to notify, when the determining unit determines that the brain information corresponding to the start command is acquired, that the first processing signal or the second processing signal is being processed.

3. The operation control device according to claim 2, wherein
the determining unit is configured to
determine, when a matching rate between the brain information acquired by the brain-information acquiring unit and brain information of a start-command threshold value is equal to or higher than a first matching rate set in advance, that the brain information corresponds to the start command, and
determine, when a matching rate between the brain information acquired by the brain-information acquiring unit and brain information of an execution-command threshold value is equal to or higher than a second matching rate that is higher than the first matching rate, that the brain information corresponds to the execution command.

4. An operation control method comprising:
acquiring brain information of a user;
determining whether the acquired brain information is brain information corresponding to an execution command representing an operation to operate an operation object;
executing processing corresponding to the execution command when it is determined that brain information corresponding to the execution command is acquired; and
notifying, when a first processing signal corresponding to the execution command is being transmitted to the operation object or a second processing signal from the operation object is being received, at least one of the user, surroundings of the user, and surroundings of the operation object that the first processing signal or the second processing signal is being processed.

5. A non-transitory computer-readable storage medium storing a program causing a computer to execute:
acquiring brain information of a user;
determining whether the acquired brain information is brain information corresponding to an execution command representing an operation to operate an operation object;
executing processing corresponding to the execution command when it is determined that brain information corresponding to the execution command is acquired; and
notifying, when a first processing signal corresponding to the execution command is being transmitted to the operation object or a second processing signal from the operation object is being received, at least one of the user, surroundings of the user, and surroundings of the operation object that the first processing signal or the second processing signal is being processed.
